(19) United States
(12) Patent Application Publication
(10) Pub. No.: US 2026/0130505 A1
(43) Pub. Date: May 14, 2026

(54) PACKABLE MONITOR STAND

(71) Applicant: Roadcase.com, Inc., Phoenix, AZ (US)

(72) Inventors: David Temby, Phoenix, AZ (US); Austin Engstrom, Phoenix, AZ (US); Eric Gilbert, Phoenix, AZ (US); William Norman, Phoenix, AZ (US)

(21) Appl. No.: 18/943,825

(22) Filed: Nov. 11, 2024

(51) Int. Cl. A47B 81/06; F16B 2/18; F16M 11/24; F16M 11/42

(52) U.S. Cl. CPC A47B 81/064; F16B 2/185; F16M 11/24; F16M 11/42

(57) ABSTRACT

A packable monitor stand includes a base frame, a vertical support frame, and a mounting bracket. The vertical support frame extends from a bottom end to a top end. The vertical support frame is removably coupled at its bottom end to the base frame. A base plate is formed at the bottom end of the vertical support frame and the base plate is received by a base plate frame assembly on the base frame to removably coupled the vertical support frame to the base frame. The is removably coupled to the vertical support frame and receives and mounts a flat panel display. The base frame may be a moveable base frame having a plurality of wheels coupled thereto.

### BACKGROUND

The presentation of visual content at events, such as corporate events, trade shows, and the like, is important for attracting and engaging attendees. Monitor stands play a role in this process by allowing for visual content to be displayed in specific locations at an event. In some instances, the monitor stands can be movable, such that they can be wheeled or rolled into position at different locations at the event.

Existing designs for monitor stands pose a number of challenges in their assembly and transportation. Many monitor stands are heavy and cumbersome to assemble, often requiring tools for assembly and disassembly. In many instances, this can lead to wasted time assembling and disassembling monitor stands when setting up for, or taking down, an event. This complexity not only increases setup time, but also complicates logistics.

Moreover, the inability to efficiently disassemble these stands means they cannot be packed into a single container for transport, leading to logistical inefficiencies and increased shipping costs. As a result, event organizers and exhibitors face obstacles in managing their display equipment, impacting their ability to create dynamic and adaptable presentations.

### SUMMARY OF THE DISCLOSURE

It is an aspect of the present disclosure to provide a monitor stand that includes a base frame, a vertical support frame, and a mounting bracket. The vertical support frame extends from a bottom end to a top end. The vertical support frame is removably coupled at the bottom end of the vertical support frame to the base frame. The mounting bracket receives and mounts a flat panel display. The mounting bracket is removably coupled to the vertical support frame.

### BRIEF DESCRIPTION OF THE DRAWINGS

FIG. 1A shows a front view of a monitor stand according to some embodiments described in the present disclosure.

FIG. 1B shows a back view of a monitor stand according to some embodiments described in the present disclosure.

FIG. 1C shows an exploded view of a monitor stand according to some embodiments described in the present disclosure.

FIG. 2A shows an example base frame of a monitor stand according to some embodiments described in the present disclosure.

FIG. 2B shows an alternative configuration of a base plate frame assembly.

FIG. 2C shows another alternative configuration of a base plate frame assembly.

FIG. 3 shows a toggle clamp that can be used to secure a base plate of a vertical support frame of a monitor stand to a base plate frame assembly.

FIG. 4A shows an example vertical support frame of a monitor stand according to some embodiments described in the present disclosure.

FIG. 4B shows an alternative configuration of the vertical support frame having a hinged design.

FIG. 4C shows another alternative configuration of the vertical support frame having pieces that fit together via an interference fit.

FIGS. 5A-5C show an example mounting bracket that can be removably coupled to the vertical support frame of a monitor stand.

FIGS. 6A and 6B show an example laptop stand that can be removably coupled to the vertical support frame of a monitor stand.

FIG. 7 is a flowchart of an example method for assembling a monitor stand according to some embodiments described in the present disclosure.

FIGS. 8A-8C show examples of multiple monitor stands being efficiently packed into road cases for transportation according to some embodiments described in the present disclosure.

### DETAILED DESCRIPTION

Described here are packable monitor stands that can be rapidly assembled, adjusted, and disassembled without the need for tools. The monitor stand includes a base frame that in some embodiments can be a moveable base frame that allows for the monitor stand to be moved (e.g., wheeled, rolled) between different locations. A vertical support frame is removably coupled to the base frame. A mounting bracket can be slid onto and coupled to the vertical support frame. The mounting bracket supports at least one monitor, television, or other display panel. In some embodiments, a laptop stand can also be coupled to the vertical support frame. The laptop stand can support a laptop, tablet computer, or other mobile computing device to be connected to the monitor to display content. When disassembled, the components of the monitor stand can be packed into a road case or other suitable storage container. Advantageously, the components for multiple monitor stands can be packed in a single road case, allowing for efficient packing and transportation of monitor stands.

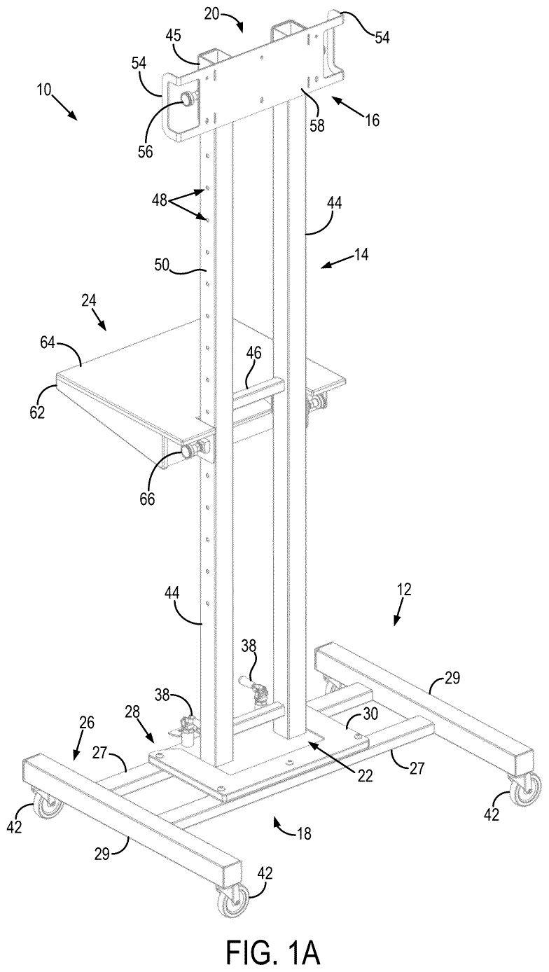

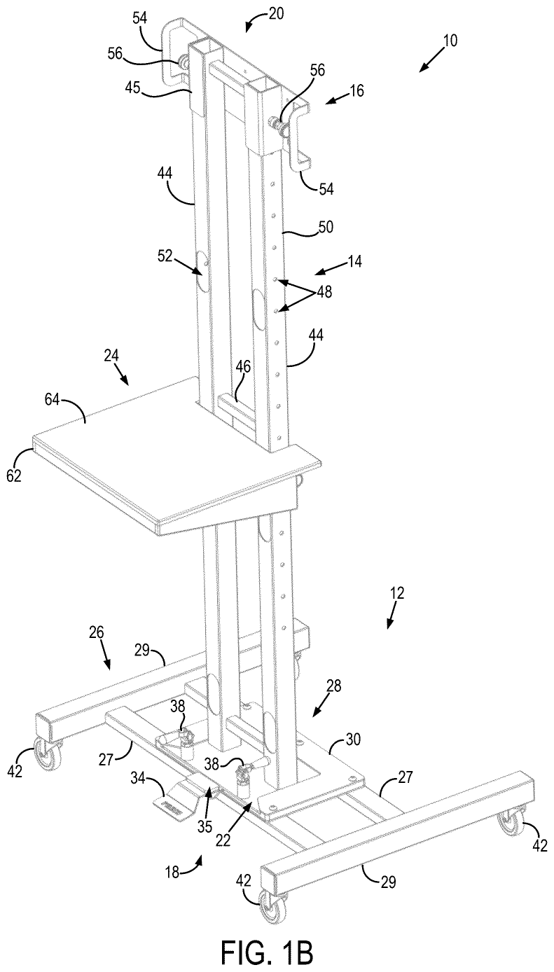

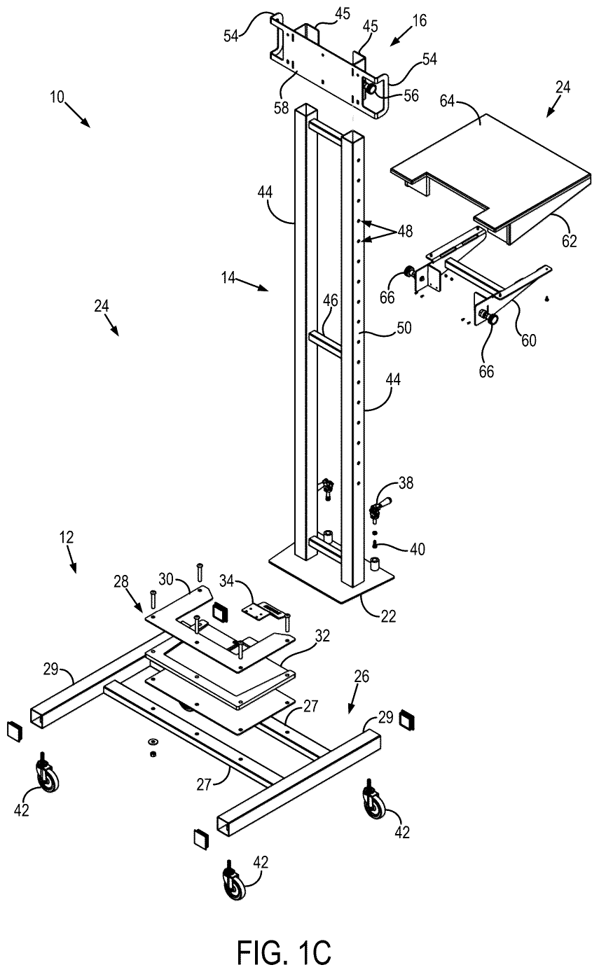

FIG. 1A shows a front view of the monitor stand 10 according to some embodiments described in the present disclosure. FIG. 1B shows a back view of the monitor stand 10 according to some embodiments described in the present disclosure. FIG. 1C shows an exploded view of the monitor stand 10 according to some embodiments described in the present disclosure.

The monitor stand 10 includes a base frame 12, a vertical support frame 14, and a mounting bracket 16 for receiving and mounting a monitor, television, or other display panel. The vertical support frame 14 extends from a bottom end 18 to a top end 20. The vertical support frame 14 is removably coupled at its bottom end 18 to the base frame 12 via a base plate 22. The mounting bracket 16 is removably coupled to the vertical support frame 14. The monitor stand 10 may also include a laptop stand 24 for receiving and supporting a laptop, tablet computer, or other mobile computing device. The laptop stand 24 is also removably coupled to the vertical support frame 14. Advantageously, the mounting bracket 16 and laptop stand 24 can be positioned on either side (i.e., the front side or the back side) of the vertical support frame 14, allowing for a customizable setup of the monitor stand 10.

The components of the monitor stand 10 may be composed of materials such as steel, aluminum, or other metals or metal alloys. Additionally or alternatively, the components of the monitor stand 10 may be composed of composite materials, such as fiberglass reinforced plastic; polymer materials; or the like.

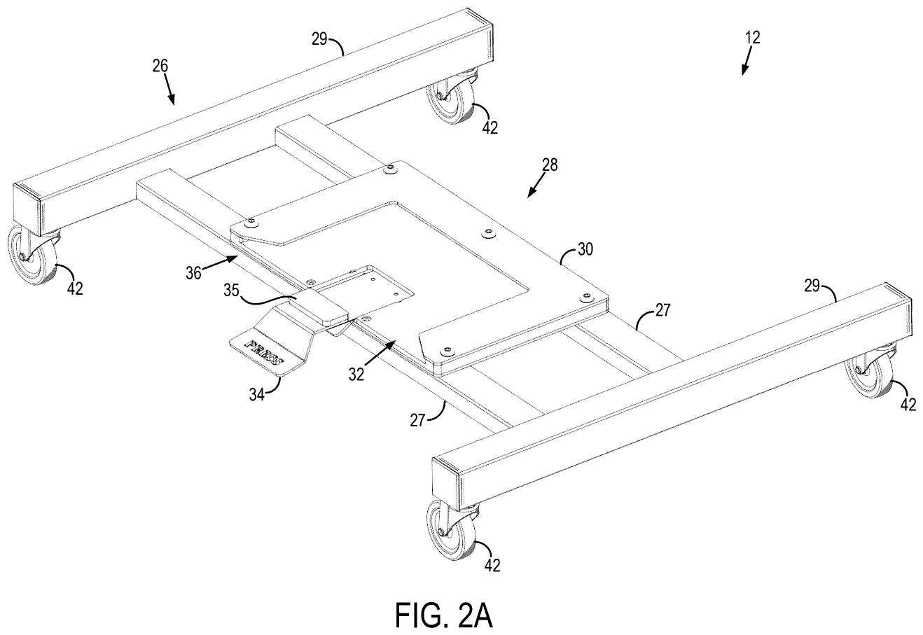

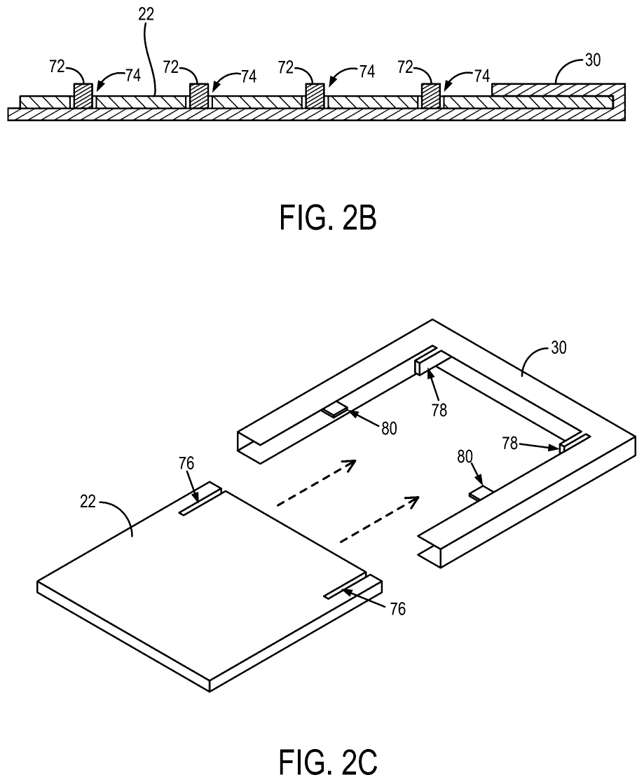

As illustrated in FIG. 2A, the base frame 12 includes a horizontal base support 26 to which a base plate frame assembly 28 is attached or otherwise coupled. In the illustrated example, the horizontal base support 26 includes two parallel support members 27 that span a distance between two end support members 29 that are orthogonal to the parallel support members 27.

The base plate frame assembly 28 generally includes a base plate frame 30, a locking plate 32, and a release tab 34. The base plate frame 30 is shaped to receive the base plate 22 of the vertical support frame 14. In the illustrated example, the base plate frame 30 is enclosed on three sides and has an open side 36 on its fourth side. The base plate 22 of the vertical support frame 14 is slid into the base plate frame 30 via the open side 36. The locking plate 32 is arranged at the bottom of the base plate frame 30. In some embodiments, the locking plate 32 is composed of spring steel or another suitable material that tends to return to its original shape when deflected. For instance, the locking plate 32 may be composed of another material with a high yield strength.

When the base plate 22 of the vertical support frame 14 is slid into the base plate frame 30 it is slid over the top of the locking plate 32 and depresses the locking plate 32 downward. In turn, the locking plate 32 tends to press upwards against the base plate 22, biasing the base plate 22 against the inner surface of the base plate frame 30. As a result, the locking plate 32 secures the base plate 22 within the base plate frame 30, thereby securely coupling the vertical support frame 14 to the base frame 12. This action provides a quick securement of the vertical support frame 14 to the base frame 12, which provides an added safety measure that prevents the vertical support frame 14 from slipping out of the base frame 12 should the monitor stand 10 be moved without further securing the vertical support frame 14 to the base frame 12. In the illustrated example, the base plate frame assembly 28 can also include a backstop 35 that helps prevent the base plate 22 from slipping out of the base plate frame 30. The backstop 35 can be deflected downwards when depressing the release tab 34 to allow the base plate 22 to be slid out of the base plate frame 30 for disassembly.

In an alternative configuration, the base plate frame assembly 28 may not include a locking plate 32, but can instead secure the base plate 22 within the base plate frame 30 using other means for securing the base plate 22 within the base plate frame 30. As one non-limiting example, shown in FIG. 2B, a series of retractable pins 72 may be arranged along the bottom surface of the base plate frame 30. The base plate 22 may then also have a corresponding series of holes 74 formed in the body of the base plate 22. As the base plate 22 is slid into the base plate frame 30, the retractable pins 72 are pushed down and out of the way. When the base plate 22 is arranged such that the holes 74 are aligned with the retractable pins 72 then the retractable pins 72 will engage with the holes 74 and secure the base plate 22 within the base plate frame 30. Depressing the release tab 34 can push and/or pull the retractable pins 72 downward to release the base plate 22, thereby allowing the base plate 22 to be slid out of the base plate frame 30 for disassembly.

In yet another alternative configuration, such as the configuration illustrated in FIG. 2C, the base plate frame assembly 28 may not include a locking plate 32, but can instead secure the base plate 22 within the base plate frame 30 by forming one or more receiving slots 76 in the base plate 22 that may be received by one or more holders 78 formed in or otherwise coupled to the base plate frame 30. When the base plate 22 is slid into the base plate frame 30, the holders 78 are received by the receiving slots 76 to secure the base plate 22 within the base plate frame 30. The holders 78 may provide a downward pressure that locks the base plate 22 within the base plate frame 30, or may provide an upward pressure that locks the base plate 22 within the base plate frame 30. For example, the holders 78 may be flanged at their top end and/or bottom end to provide additional securement of the base plate 22 when the holders 78 are arranged within the receiving slots 76. The base plate 22 can be released from the base plate frame 30 using the release tab 34 to retract the holders 78 from the receiving slots 76, or alternatively one or more tabs 80 may be arranged on the base plate frame 30 that are operable to selectively secure the base plate 22 within the base plate frame 30. For example, the tabs 80 may be operable to provide pressure against the base plate 22 when the holders 78 are arranged within the receiving slots 76. The tabs 80 can, for example, be operated by hand.

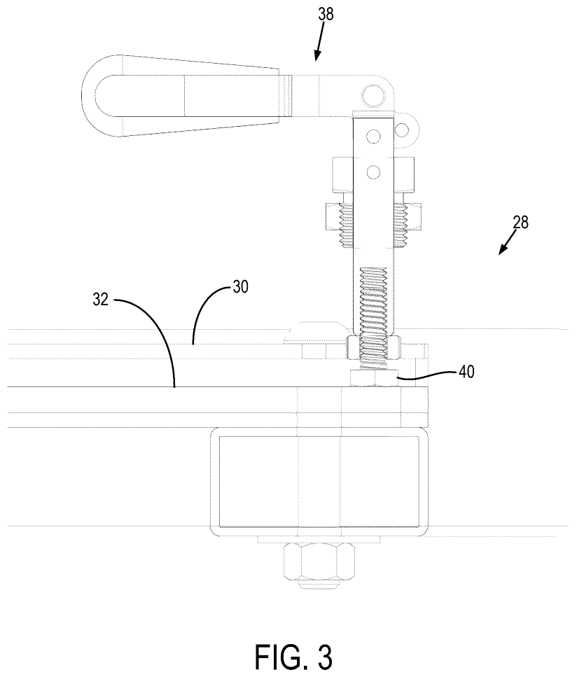

After the base plate 22 is secured in the base plate frame 30, the vertical support frame 14 can be further secured in place by actuating toggle clamps 38 on the base plate 22. As shown in FIG. 3, the toggle clamps 38 receive and pull upwards on bolts 40 in the base plate frame assembly 28 to provide added pressure that holds the base plate 22 in place within the base plate frame 30. To disassemble the monitor stand 10, the toggle clamps 38 are released and the release tab 34 is depressed. Actuating the release tab 34 releases tension on the locking plate 32, which allows for the base plate 22 to be slid out of the base plate frame 30.

In some embodiments, the base frame 12 is a moveable base frame. For example, the base frame 12 can include wheels 42 that allow for the monitor stand 10 to be moved from location to location. The wheels 42 may be, for example, caster wheels. In some instances, the caster wheels may be lockable caster wheels such that when the monitor stand 10 is moved to a desired location the caster wheels can be locked to prevent further movement of the monitor stand 10. Likewise, the caster wheels can be locked prior to coupling the vertical support frame 14 to the base frame 12 to prevent the monitor stand 10 from moving during assembly. In the illustrated examples, the wheels 42 may be attached on opposite ends of the end support members 29 of the horizonal base support 26.

In some other embodiments, the base frame 12 is a stationary base frame. In these instances, the base frame 12, and by extension the monitor stand 10, is constructed to remain in a fixed location. When the monitor stand 10 is configured as a stationary monitor stand, the base plate frame 30 can optionally be constructed without a locking plate 32 and release tab 34.

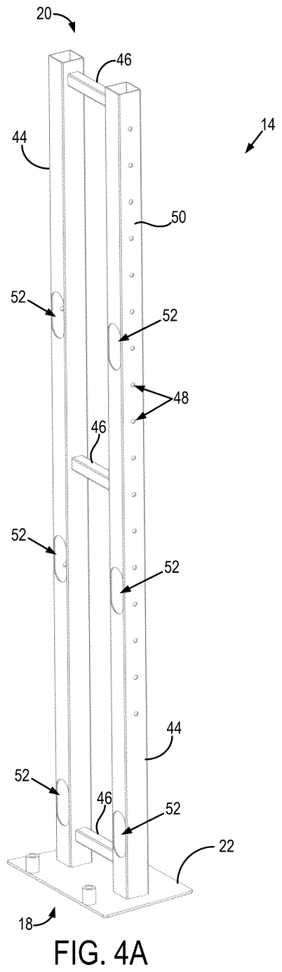

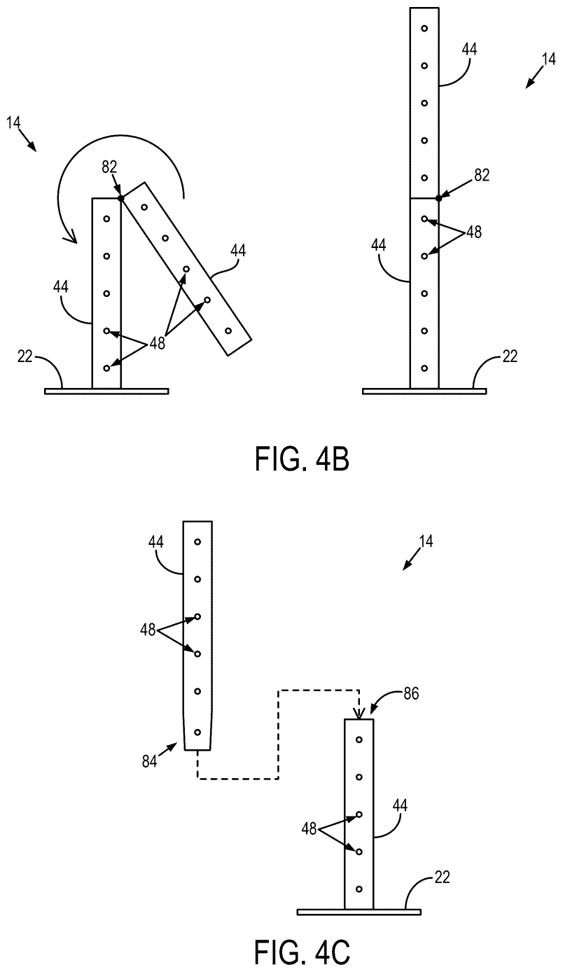

As illustrated in FIGS. 1A-1C and FIGS. 4A-4C, the vertical support frame 14 includes two vertical support members 44 that are horizontally offset from each other. The vertical support members 44 are coupled to the base plate 22 at the bottom end 18 of the vertical support frame 14. For example, the vertical support members 44 can be welded or otherwise integrally formed with the base plate 22.

One or more horizontal support members 46 can span the distance between the vertical support members 44 to provide structural rigidity to the vertical support frame 14. A series of holes 48 are formed in the outer side faces 50 of the vertical support members 44. The series of holes 48 are sized to receive pins, retractable spring plungers, or the like for securing accessories to the vertical support frame 14. For example, the series of holes 48 can be used to secure the mounting bracket 16 and laptop stand 24 to the vertical support frame 14. The holes 48 are positioned at the same vertical positions on the outer side faces 50 of the vertical support members 44 such that a pair of holes 48 on each vertical support member 44 are aligned with each other to provide level attachment of accessories via that pair of holes 48. The holes 48 may be uniformly spaced apart along the length of the vertical support members 44, or may be nonuniformly spaced apart.

The vertical support members 44 are preferably constructed as hollow tubes. This configuration provides a more lightweight construction. Additionally, by having the vertical support members 44 constructed as hollow tubes the vertical support members 44 can be used as cable passthroughs. In these instances, cable holes 52 are formed on the back side of the vertical support members 44 to allow a passthrough for cables between the monitor, the laptop, and a power outlet, ethernet port, or other electrical connection. In the illustrated example, a set of cable holes 52 is provided at the top end 20 of the vertical support frame 14, the middle of the vertical support frame 14, and the bottom end 18 of the vertical support frame 14. The vertical support members 44 can also be open at their top end to allow for cables to be passed through from the top end 20 of the vertical support frame 14.

In some configurations, the vertical support frame 14 can be broken down into smaller pieces for improved packing efficiency. As one non-limiting example, shown in FIG. 4B, each vertical support member 44 of the vertical support frame 14 may be constructed as two or more pieces that are coupled together via hinge points 82. When unpacked, the vertical support members 44 may then be unfolded along the hinge points 82 to arrange the vertical support frame 14 into its deployed state, as illustrated in FIGS. 1A-1C. The vertical support members 44 may then be locked into place to prevent folding of the vertical support members 44 when the vertical support frame 14 is in use. As one non-limiting example, the vertical support members 44 may be locked into place using one or more push pins that extend through holes 48 in the vertical support members 44 to prevent unfolding of the vertical support members 44 at the hinge points 82.

As another non-limiting example, shown in FIG. 4C, the vertical support members 44 may be constructed as two or more pieces that can be coupled together via an interference fit, or the like. For instance, each vertical support member 44 may have a tapered bottom end 84 that is received by the open top end 86 of the other piece of the vertical support member 44. When the tapered bottom end 84 is received by the open top end 86, a push pin, retractable spring plunger, or the like can be used to secure the two pieces of the vertical support member 44 together, such as by engaging the push pin, retractable spring plunger, or the like through holes 48 in the vertical support member.

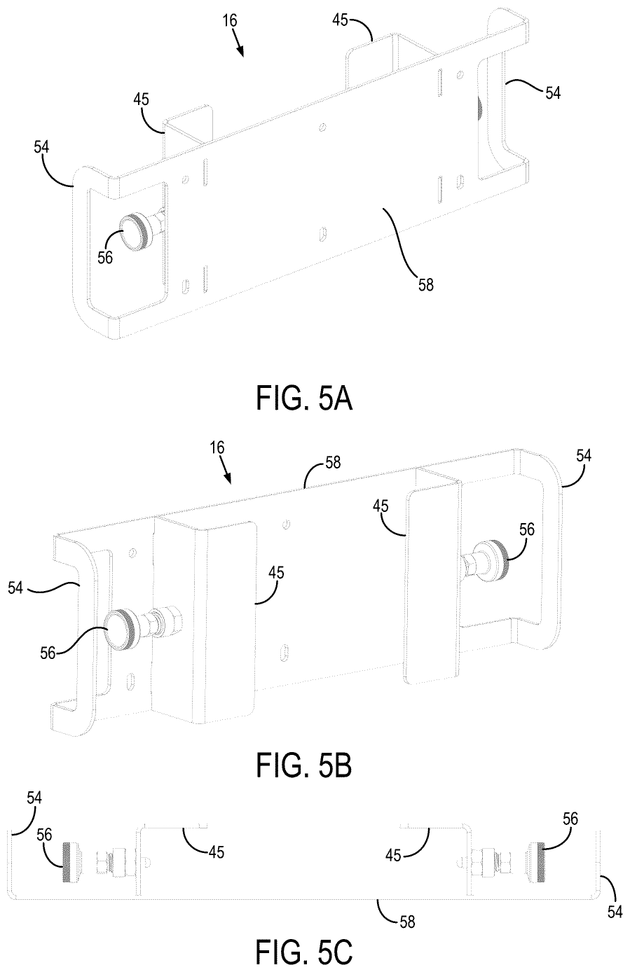

The mounting bracket 16 can be removably coupled to the vertical support frame 14 at different positions along the length of the vertical support frame 14 via coupling of the mounting bracket 16 to respective holes 48 in the vertical support members 44. The mounting bracket 16 is slid onto the vertical support members 44 from the top end 20 of the vertical support frame 14. For instance, the mounting bracket 16 includes two channels 45 formed on the back side of the mounting bracket 16 that are sized and shaped to receive the vertical support members 44 of the vertical support frame. The channels 45 may fully enclose the vertical support members 44, or as illustrated in FIGS. 5A-5C, the channels 45 may be open on one side to allow for easier positioning of the mounting bracket 16 on the vertical support members 44.

When positioned at the desired height or vertical position on the vertical support frame 14, the mounting bracket 16 is coupled to the vertical support frame 14 by engaging pins, retractable spring plungers, or the like, into the respective holes 48 on the vertical support members 44. This construction allows for rapid, repeatable coupling of the mounting bracket 16 to the vertical support frame 14 without the need for additional tools.

In some embodiments, the mounting bracket 16 can include handles 54 on its sides to improve handling of the mounting bracket 16 by a user. In the illustrated example, two retractable spring plungers 56 are arranged on opposite sides of the mounting bracket 16 for coupling the mounting bracket 16 to the vertical support frame 14. For instance, the retractable spring plungers 56 are coupled to the channels 45 on the back side of the mounting bracket 16. A hole in each channel 45 allows for the plunger of the retractable spring plunger 56 to pass through the channel 45 to engage the holes 48 on the vertical support member 44. The retractable spring plungers 56 are positioned such that when a user is holding onto the handles 54 the retractable spring plungers 56 can be reached and actuated to disengage the spring plungers 56 and released to engage the spring plungers 56 when the mounting bracket 16 is positioned on the vertical support frame 14.

The mounting bracket 16 includes a mounting plate 58 to which a flat panel display, such as a monitor, television, or other display panel, can be mounted or otherwise coupled. In some embodiments, the flat panel display may include a curved display panel (e.g., a curved monitor or other curved flat panel display). As a non-limiting example, the mounting plate 58 can include a flat display mounting interface (FDMI), which may include a Video Electronics Standards Association (VESA) standard mounting for receiving and securely mounting a monitor, television, or other display panel. In other constructions, the mounting plate 58 may include other configurations for mounting a monitor, television, or other display panel. In the illustrated example, the handles 54 are integrally formed with the mounting plate 58. In other configurations, the handles 54 may be constructed as separate elements that are attached or otherwise coupled to the mounting plate 58. In still other configurations, the mounting bracket 16 may include a mounting plate 58 without any handles 54.

In the illustrated example, the monitor stand 10 can mount a single flat panel display, such as a monitor, television, or other display panel. In other embodiments, the mounting bracket 16 can be constructed to allow for mounting of more than one flat panel display.

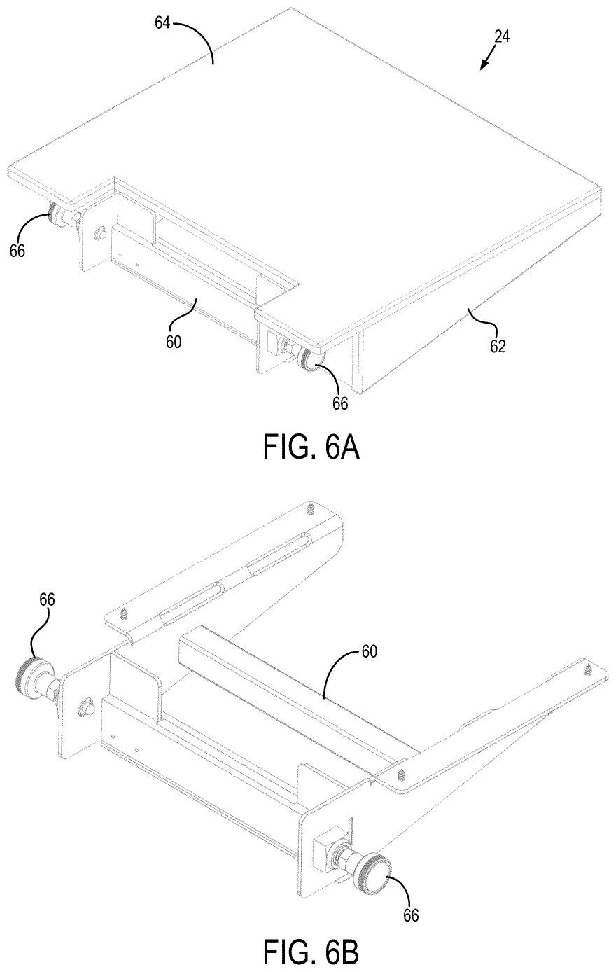

As illustrated in FIGS. 6A and 6B, the laptop stand 24 includes a stand bracket 60 and a shelf 62. The shelf 62 is affixed to, or otherwise coupled to, the stand bracket 60 and provides a stable support surface for a laptop, tablet computer, or other mobile computing device. In general, the shelf 62 includes a flat, or otherwise planar surface 64, for receiving a laptop, tablet computer, or other mobile computing device. The stand bracket 60 removably couples the laptop stand 24 to the vertical support frame 14. Like the mounting bracket 16, the stand bracket 60 can be removably coupled to the vertical support frame 14 by engaging pins, retractable spring plungers, or the like, into the holes formed on the vertical support members. For example, the stand bracket 60 can include retractable spring plungers 66 on opposite sides of the stand bracket 60. The retractable spring plungers 66 are actuated to disengage so the laptop stand 24 can be slid onto the vertical support members 44 and arranged into the desired vertical position on the vertical support frame 14. When positioned, the retractable spring plungers 66 are released to engage the holes 48 in the vertical support members 44, thereby securing the laptop stand 24 in position on the vertical support frame 14 without the need to additional tools.

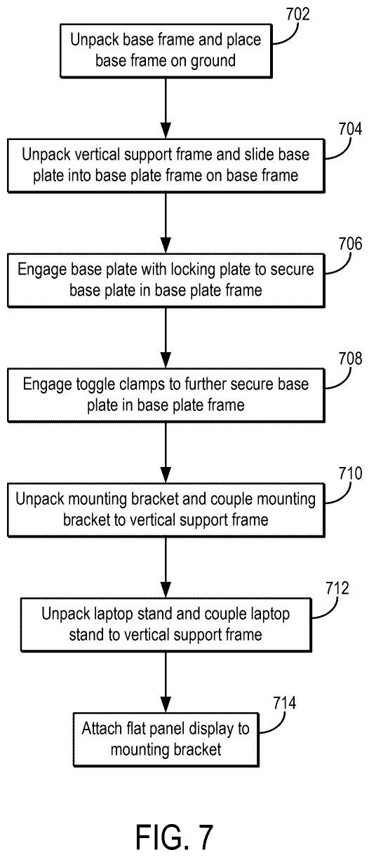

Referring now to FIG. 7, a flowchart is illustrated as setting forth the steps of an example method for assembling a monitor stand 10 in accordance with some embodiments described in the present disclosure. To assemble the monitor stand 10, a user first unpacks the base frame 12 and places the base frame 12 on the ground, as indicated at step 702. When the base frame 12 is a moveable base frame, the wheels 42 (e.g., caster wheels) are locked to prevent movement of the base frame 12 during the assembly process.

A user then unpacks the vertical support frame 14 and inserts the base plate 22 at the bottom end 18 of the vertical support frame 14 into the base plate frame 30 in the base frame 12 to couple the vertical support frame 14 to the base frame 12, as indicated at step 704. The vertical support frame 14 is locked into place by engaging the base plate 22 with the locking plate 32 on the base plate frame assembly 28, as indicated at step 706. For example, as the base plate 22 is slid into the base plate frame 30 the locking plate 32 biases the base plate 22 upwards against the inner surface of the base plate frame 30 and holds the base plate 22 securely in the base plate frame 30, thereby securing the vertical support frame 14 to the base frame 12. One or more toggle clamps 38 on the base plate 22 can additionally be actuated to provide pressure to the base plate 22 to further secure the base plate 22 within the base plate frame 30, as indicated at step 708.

A user then unpacks the mounting bracket 16 and couples the mounting bracket 16 to the vertical support frame 14, as indicated at step 710. The mounting bracket 16 can be coupled to the vertical support frame 14 by way of pins, retractable spring plungers, or the like. For example, the mounting bracket 16 can include two retractable spring plungers 56 on each side of the mounting bracket 16, as illustrated in FIGS. 5A-5C. While retracting the spring plungers 56, the mounting bracket 16 can be slid onto the vertical support frame 14 from its top end 20. The mounting bracket 16 is then slid into position at the desired height along the length of the vertical support frame 14. The spring plungers 56 are then released to engage with the holes 48 formed along the length of the vertical support members 44 of the vertical support frame 14 to secure the mounting bracket 16 in position. The holes 48 formed along the length of the vertical support members 44 ensure level placement of the mounting bracket 16 each time. This is an advantage over monitor stands that use set screws, or the like, to provide placement of a mounting bracket 16, which may not always be level.

A user then unpacks the laptop stand 24 and couples the laptop stand 24 to the vertical support frame 14, as indicated at step 712. The laptop stand 24 can be coupled to the vertical support frame 14 by way of pins, retractable spring plungers, or the like. For example, the laptop stand 24 can include two retractable spring plungers 66 on each side of the stand bracket 60 of the laptop stand 24, as illustrated in FIGS. 6A and 6B. While retracting the spring plungers 66, the laptop stand 24 can be slid into position on the vertical support frame 14. The spring plungers 66 are then released to engage with the holes formed along the length of the vertical support members 44 of the vertical support frame 14 to secure the laptop stand 24 in position. The holes 48 formed along the length of the vertical support members 44 ensure level placement of the laptop stand 24 each time.

A user then attaches or otherwise couples a flat panel display (e.g., a monitor, a television, another display panel) to the mounting bracket 16, as indicated at step 714. A user can also pass relevant cables through the hollow centers of the vertical support members 44. Cables can be passed through from the open top end of the vertical support members 44 and through cable holes 52 formed in the back side of each vertical support member 44.

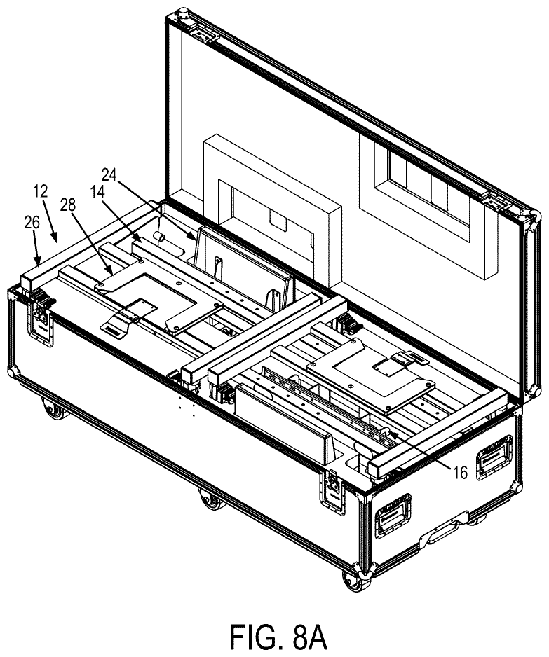

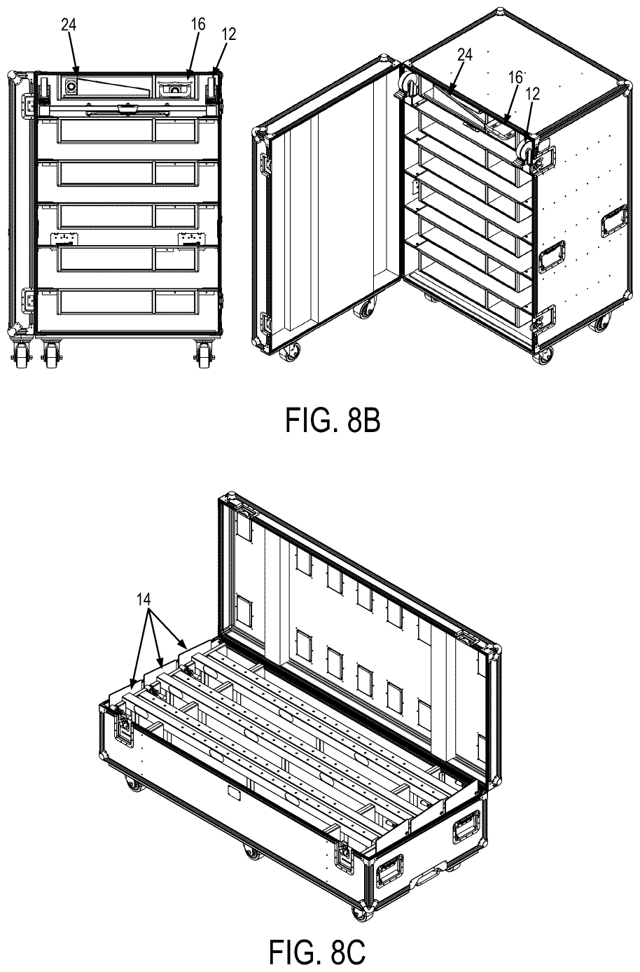

The monitor stand 10 can then be moved to a desired location, such as by rolling the monitor stand 10 using the wheels 42. When it is time to disassembly the monitor stand 10, the preceding steps can be performed in reverse to break down the various components of the monitor stand 10 and to pack the components into a road case or other suitable storage container. For instance, after disassembling the monitor stand 10, the base frame 12, vertical support frame 14, mounting bracket 16, and laptop stand 24 can be packed in a road case or other suitable storage container. Advantageously, the design of the monitor stand 10 allows for the components of multiple monitor stands to be packed into a single road case. As one example, a road case can be configured to contain the components for two monitor stands, as illustrated in FIG. 8A. As another example, two road cases can be configured to contain the components for six monitor stands, as illustrated in FIGS. 8B and 8C. It will be appreciated that road cases or other storage containers can similarly be designed to contain the components for different numbers of monitor stands.

The present disclosure has described one or more preferred embodiments, and it should be appreciated that many equivalents, alternatives, variations, and modifications, aside from those expressly stated, are possible and within the scope of the invention.

1. A monitor stand, comprising:
a base frame;
a vertical support frame extending from a bottom end to a top end, wherein the vertical support frame is removably coupled at the bottom end of the vertical support frame to the base frame; and
a mounting bracket for receiving and mounting a flat panel display, wherein the mounting bracket is removably coupled to the vertical support frame.

2. The monitor stand of claim 1, wherein the vertical support frame comprises a base plate affixed to the bottom end of the vertical support frame, wherein the base plate removably couples the vertical support frame to the base frame.

3. The monitor stand of claim 2, wherein the base frame comprises a horizonal base support and a base plate frame assembly coupled to the horizontal base support, wherein the base plate frame assembly receives the base plate when removably coupling the vertical support frame to the base frame.

4. The monitor stand of claim 3, wherein the base plate frame assembly comprises a base plate frame and a locking plate arranged within the base plate frame, wherein when the base plate is slid into the base plate frame the locking plate biases the base plate against an inner surface of the base plate frame to securely retain the base plate within the base plate frame.

5. The monitor stand of claim 4, wherein the locking plate is composed of a spring steel.

6. The monitor stand of claim 4, wherein the base plate frame assembly further comprises a release tab coupled to the locking plate such that depressing the release tab releases tension from the locking plate.

7. The monitor stand of claim 3, further comprising at least one toggle clamp arranged on a top surface of the base plate, wherein engaging the at least one toggle clamp when the base plate is arranged within the base plate frame assembly provides a pressure on the base plate that secures the base plate within the base plate frame assembly.

8. The monitor stand of claim 7, wherein the at least one toggle clamp receives a bolt coupled to the base plate frame assembly such that when the at least one toggle clamp is engaged the bolt is pulled upwards to provide the pressure on the base plate.

9. The monitor stand of claim 3, wherein the horizonal base support comprises two parallel horizonal support members spanning between two opposed end support members.

10. The monitor stand of claim 1, wherein the base frame is a moveable base frame and a plurality of wheels are coupled to the two opposed end support members of the horizontal base support.

11. The monitor stand of claim 1, wherein the vertical support frame comprises a first vertical support member horizontally offset from a second vertical support member.

12. The monitor stand of claim 11, wherein the first vertical support member has a first plurality of holes formed in an outer edge surface of the first vertical support member and the second vertical support member has a second plurality of holes formed in an outer edge surface of the second vertical support member.

13. The monitor stand of claim 12, wherein the mounting bracket includes a first retractable spring plunger arranged on a first side of the mounting bracket to engage the first plurality of holes and a second retractable spring plunger arranged on a second side of the mounting bracket that is opposite the first side of the mounting bracket to engage the second plurality of holes.

14. The monitor stand of claim 12, wherein the mounting bracket comprises a mounting plate having a front side and a back side, wherein a first channel and a second channel are formed on the back side of the mounting plate, wherein the first channel receives the first vertical support member and the second channel receives the second vertical support member when removably coupling the mounting bracket to the vertical support frame.

15. The monitor stand of claim 14, wherein the mounting plate has formed therein a flat panel display interface for receiving and mounting a flat panel display to the mounting bracket.

16. The monitor stand of claim 11, wherein at least one of the first vertical support member or the second vertical support member are hollow.

17. The monitor stand of claim 16, wherein at least one cable hold is formed in a back side surface of at least one of the first vertical support member or the second vertical support to receive and pass through cables.

18. The monitor stand of claim 1, further comprising a laptop stand for receiving and supporting a computing device, wherein the laptop stand is removably coupled to the vertical support frame.

19. The monitor stand of claim 18, wherein the laptop stand comprises a stand bracket and a shelf coupled to the stand bracket, wherein the shelf comprises a flat planar surface for receiving and supporting the computing device.

20. The monitor stand of 19, wherein the stand bracket includes a first retractable spring plunger arranged on a first side of the stand bracket to engage the first plurality of holes and a second retractable spring plunger arranged on a second side of the stand bracket that is opposite the first side of the stand bracket to engage the second plurality of holes.
